(19) United States
(12) Patent Application Publication
(10) Pub. No.: US 2013/0242894 A1
(43) Pub. Date: Sep. 19, 2013

(54) WIRELESS COMMUNICATION APPARATUS AND WIRELESS COMMUNICATION METHOD

(71) Applicant: FUJITSU LIMITED, Kawasaki-shi (JP)

(72) Inventor: Tetsuya KIKUCHI, Yokosuka (JP)

(73) Assignee: FUJITSU LIMITED, Kawasaki-shi (JP)

(21) Appl. No.: 13/748,354

(22) Filed: Jan. 23, 2013

(30) Foreign Application Priority Data
Mar. 19, 2012 (JP) 2012-062183

(51) Int. Cl. H04W 72/12

(52) U.S. Cl. CPC H04W 72/1278
USPC 370/329

(57) ABSTRACT

A wireless communication apparatus includes: a wireless circuit; and a communication control processor configured to execute processing for uplink and processing for downlink, by using the wireless circuit in a time-sharing manner based on a given execution schedule, change the time-sharing execution schedule so as to raise an execution order of processing for the uplink, when an uplink signal is judged to include data indicating delivery confirmation in an upper layer based on a data amount of the uplink signal which is input for the uplink from an upper processor which executes processing on the upper layer than a communication layer where the communication control processor executes processing, and transmit an uplink signal including data indicating delivery confirmation in the upper layer, by using processing for uplink to be executed based on the time-sharing execution schedule after change.

### CROSS-REFERENCE TO RELATED APPLICATION

This application is based upon and claims the benefit of priority of the prior Japanese Patent Application No. 2012-062183, filed on Mar. 19, 2012, the entire contents of which are incorporated herein by reference.

### FIELD

The embodiments discussed herein are related to a wireless communication apparatus and a wireless communication method.

### BACKGROUND

Currently, wireless communication systems such as cellular phone systems or wireless LANs (Local Area Network) or the like are widely employed. With such a wireless communication system, various services such as a moving image distribution services are provided besides communication services. Also, with terminal devices as well, smartphones or the like are being employed besides feature phones. With such a wireless communication system, e.g., TCP/IP (Transmission Control Protocol/Internet Protocol) packets conforming to the TCP/IP protocol are transmitted/received, and accordingly, connection to the Internet or the like is facilitated.

For example, with a terminal device, there may be a case where the terminal device is connected to the Internet to perform downloading of a file or a moving image or the like. In the event that the TCP/IP protocol is employed, download is performed while the transmission side confirms whether or not data has correctly been received at the terminal device, for example. In this case, in the event that specified data has been received without error, the terminal device transmits TCP/IP_ACK (ACKnowledgement) to the transmission side as a delivery confirmation signal. Thus, for example, the transmission side is allowed to confirm that data has correctly been received at the terminal device. Accordingly, the TCP/IP protocol is also called a delivery confirmation typed protocol.

However, generation of TCP/IP packets is performed at the transport layer, and identification of TCP/IP packets or the like is not performed at the L2 layer, L1 layer, and so forth positioned in lower than the transport layer. Accordingly, distinction of the identifier of TCP/IP_ACK included in the TCP header, or the like is not performed at the L2 layer, L1 layer, and so forth.

On the other hand, delivery confirmation of data is performed at each of the L1 layer and L2 layer. For example, with the L1 layer, a delivery confirmation signal conforming to HARQ (Hybrid Automatic Repeat reQuest) (e.g., HARQ_ACK), and with the L2 layer, a delivery confirmation signal conforming to the RLC (Radio Link Control) protocol (e.g., RCL_ACK) are employed respectively, and delivery confirmation is performed at these layers.

For example, in the event that data is transmitted using down communication link, the terminal device transmits HARQ_ACK to the transmission side (e.g., a wireless base station), whereby the transmission side may perform delivery confirmation at the L1 layer. Also, the terminal device transmits RLC_ACK to the transmission side (e.g., an RNC (Radio Network Controller) positioned in a upper than the wireless base station), whereby the transmission side may perform delivery confirmation at the L2 layer. Further, the terminal device transmits TCP/IP_ACK to the transmission side (e.g., a server or the like ranked in a higher order than the RNC), whereby the transmission side may perform delivery confirmation at the transport layer. In this way, for example, delivery confirmation may be performed at each of the L1 layer, L2 layer, and transport layer, and the transmission side may transmit the next data to the terminal device for the first time after receiving TCP/IP_ACK.

Examples of a technique relating to delivery confirmation of the TCP/IP protocol include the following. Specifically, a base station receives a TCP/IP packet from a upper station, and when detecting the final information bit of the TCP/IP packet, transmits priority assignment information to a mobile terminal. Next, the mobile terminal transmits the priority assignment information and an uplink line assignment request to the base station to transmit ACK for the TCP/IP packet to the base station. There is a base station which realizes the maximum improvement in throughput of a wireless system by raising the uplink line priority of a mobile terminal to adjust an uplink line assignment schedule when receiving priority assignment information (e.g., Japanese Laid-open Patent Publication No. 2007-266753).

Also, a technique has been proposed wherein control of a part of functions relating to the above-mentioned wireless signal transmission/reception processing are executed by firmware processing at a processor such as a DSP (Digital Signal Processor) or the like (e.g., Japanese Laid-open Patent Publication No. 2004-21884). With a computing unit which executes such firmware processing, multiple tasks relating to the above-mentioned wireless signal transmission/reception processing are executed in a time-sharing manner.

### SUMMARY

According to an aspect of the embodiments, a wireless communication apparatus includes: a wireless circuit; and a communication control processor configured to execute processing for uplink and processing for downlink, by using the wireless circuit in a time-sharing manner based on a given execution schedule, change the time-sharing execution schedule so as to raise an execution order of processing for the uplink, when an uplink signal is judged to include data indicating delivery confirmation in an upper layer based on a data amount of the uplink signal which is input for the uplink from an upper processor which executes processing on the upper layer than a communication layer where the communication control processor executes processing, and transmit an uplink signal including data indicating delivery confirmation in the upper layer, by using processing for uplink to be executed based on the time-sharing execution schedule after change.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram representing a configuration example of a mobile terminal device;

FIG. 2 is a diagram representing a configuration example of a communication system;

FIG. 3 is a diagram representing configuration examples of each of NodeB, a mobile device, and a client PC;

FIG. 4 is a diagram representing an example of data flow;

FIG. 5 is a diagram representing examples of data formats;

FIG. 6 is a diagram representing an example of the category of a wireless communication system and the maximum throughput thereof;

FIGS. 7A and 7B are flowcharts each representing an operation example of decision processing;

FIG. 8 is a flowchart representing an operation example of decision processing;

FIGS. 9A and 9B are diagrams each representing an example of memory regions in buffer memory;

FIG. 10 is a flowchart representing an operation example at the mobile device;

FIGS. 11A to 11D are diagrams each representing a transition example of data;

FIG. 12 is a diagram representing transition examples of TCP/IP data;

FIG. 13 is a diagram representing configuration examples of each of NodeB, a mobile device, and a client PC; and

FIG. 14 is a diagram representing a configuration example of the mobile device.

### DESCRIPTION OF EMBODIMENTS

Hereinafter, embodiments of the present technology will be described.

While inventing the embodiments of the present technology, observations were made regarding a related art. Such observations include the following, for example.

With a technique for wireless communication systems of a related art, priority assignment information is transmitted with up communication link and down communication link. Accordingly, of a limited number of wireless resources (e.g., time and frequency), the number of resources from which data is transmitted is reduced by an amount equivalent to priority assignment information being transmitted, and throughput deteriorates in both of up communication link and down communication link as compared to a case where no priority assignment information is transmitted.

Also, the above-mentioned delivery confirmation conforming to the TCP/IP protocol also includes a problem wherein, when the terminal device transmits TCP/IP_ACK, it takes time to transmit TCP/IP_ACK, the entire throughput including the application layer deteriorates as compared to that at the L1 layer.

With a technique of a related art to control a part of functions relating to wireless processing using a processor which executes multiple tasks in a time-sharing manner, processing for down communication link is prioritized over processing for up communication link in a task schedule of a processor included in the terminal device, and accordingly, a problem due to the above-mentioned transmission delay of TCP/IP_ACK becomes significant. Hereafter, this problem will be described.

With a typical Ethernet type LAN, at the time of the TCP/IP protocol, in the case of MTU (Maximum Transmission Unit) 1500 octets, the terminal device transmits one TCP/IP_ACK for downlink data (MSS: Maximum Segment Size, the maximum value) of 2×1460 octets. Though data in the L1 layer is changed according to a communication system such as LTE (Long Term Evolution), HSDPA+ (High Speed Downlink Packet Access+) or the like and a category thereof, several to several tens of RLC packets (e.g., 1502 octets including the header) may collectively be transmitted as one transport block. Thus, for example, with the category 4 of LTE or the like, throughput is realized at down communication link such as 150 Mbps or the like.

As described above, the terminal device transmits TCP/IP_ACK for each data of 2×1460 octets, for example. Accordingly, in the event of having received one transport block from the transmission-side device (e.g., 150 Mbps), the terminal device attempts to transmit multiple TCP/IP_ACK for a plurality of TCP packet data included in this one transport block. However, a processor of a baseband processing unit included in the terminal device executes downlink signal processing and uplink signal processing in a time-sharing manner, and accordingly, transmission data including TCP/IP_ACK is detained in a transmission buffer while a task of the downlink signal processing is executed. Moreover, in the event of downloading large amount of data such as moving image data at the terminal device, execution of a task of the downlink signal processing is prioritized over other processing. Therefore, as the amount of data to be downloaded increases, though the number of TCP/IP_ACK to be transmitted increases, execution of the downlink signal processing is prioritized at the terminal device, and accordingly, detention time of TCP/IP_ACK at the transmission buffer is prolonged. Note that the uplink signal processing and downlink signal processing to be executed at the baseband processing unit in a time-sharing manner may include processing of an interface portion with the application CPU, processing of an interface portion with the RF unit, and so forth, for example.

On the other hand, in the event of performing TCP packet transmission processing according to window control such as a sliding window system or the like, the device on the transmission side may transmit a TCP packet without awaiting reception of TCP/IP_ACK which is delivery confirmation until the amount of TCP packets reaches the window size. Thus, balance between improvement in throughput in the case of transmitting large amount of data and improvement in reliability according to delivery confirmation is realized. However, in the event that data amount transmitted without awaiting delivery confirmation has reached the window size, the device on the transmission side stands ready to transmit a TCP packet until TCP/IP_ACK which is delivery confirmation for transmitted data is received. Moreover, as a result of the downlink signal processing being prioritized at the terminal device, delay occurs on reception of TCP/IP_ACK at the device on the transmission side. Therefore, with the device on the transmission side, a period for data waiting for delivery confirmation being detained in the buffer at the device on the transmission side is prolonged, and the amount of data to be able to be transmitted without awaiting delivery confirmation is suppressed. That is to say, in order to continuously transmit the amount of data corresponding to the window size, the device on the transmission side awaits reception of TCP/IP_ACK indicating delivery confirmation for the amount of data transmitted without awaiting delivery confirmation. For example, when receiving a part or all of multiple TCP/IP_ACK for a plurality of data transmitted without awaiting delivery confirmation, the device on the transmission side transmits the next data corresponding to the window size.

Accordingly, though the transmission side may transmit data of 150 Mbps at the L1 layer, throughput deteriorates due to delay of TCP/IP_ACK at the transport layer as compared to the L1 layer, for example. Therefore, the entire throughput including the application layer which is a further upper layer deteriorates as compared to the throughput at the L1 layer in the cased that no delivery confirmation is performed.

Therefore, it has been found to be desirable to provide a wireless communication apparatus including a baseband processing unit which improves transmission throughput of TCP/IP_ACK, and a program to be executed at the wireless communication apparatus.

### First Embodiment

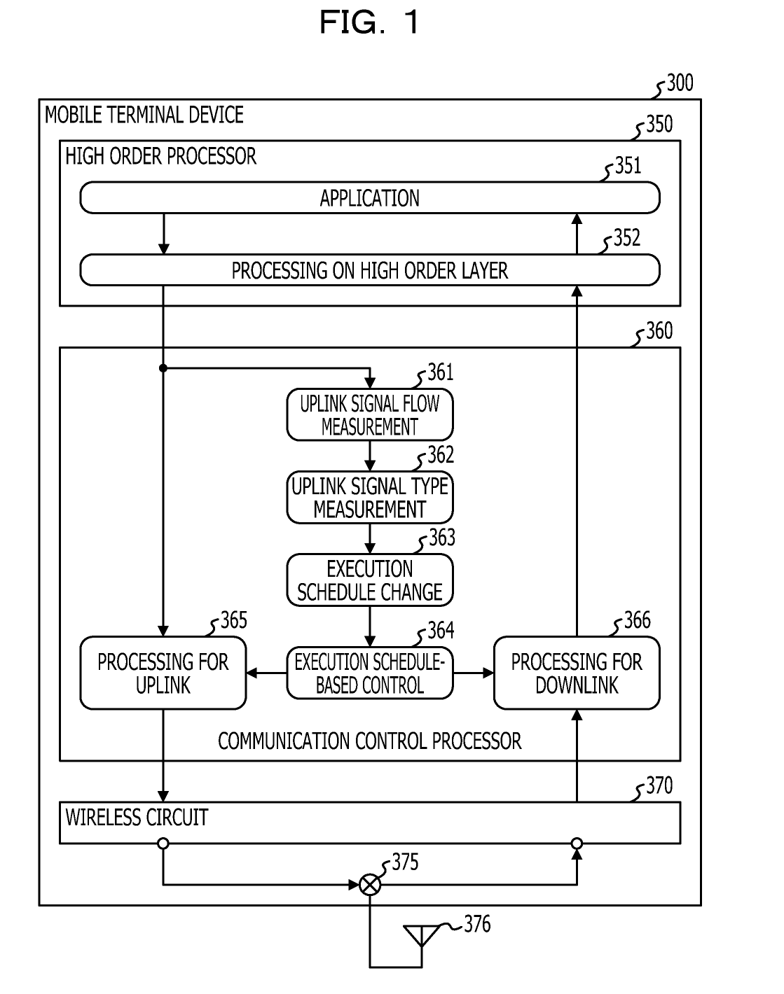

First, a first embodiment will be described. FIG. 1 is a diagram representing a configuration example of a mobile terminal device 300 according to the first embodiment. The mobile terminal device 300 is capable of wirelessly communicating with a wireless base station device, transmitting a signal to the wireless base station device, and receiving a signal transmitted from the wireless base station. For example, communication link where a signal is transmitted from the mobile terminal device 300 to the wireless base station device may be referred to as uplink, and communication link where a signal is transmitted from the wireless base station device to the terminal device 300 may be referred to as downlink. Note that the mobile terminal device 300 is an example of a wireless communication apparatus, and the wireless base station device is also an example of a wireless communication apparatus.

The mobile terminal device 300 includes an upper processor 350, a communication control processor 360, a wireless circuit 370, a mixer 375, and an antenna 376.

The upper processor 350 includes each function block of an application 351 and processing on upper layer 352. The application 351 and the processing on the upper layer 352 are function blocks to be each executed at the upper processor 350. The upper processor 350 reads out a program stored in ROM (Read Only Memory) which is not illustrated, loads this to RAM (Random Access Memory) which is not illustrated, and executes this loaded program, whereby the function blocks such as the application 351, processing on upper layer 352, and so forth may be executed (realized).

The application 351 is a function block to perform transmission/reception of e-mail, or to perform a browsing function for browsing a website, and so forth, for example. The upper processor 350 executes various applications at the application 351.

The processing on upper layer 352 generates data conforming to the TCP/IP protocol, transmits this data to the wireless base station device via the communication control processor 360, and receives this data received via the communication control processor 360. The processing on upper layer 352 generates, for example, data indicating delivery confirmation for a downlink signal transmitted from the wireless base station device (e.g., data such as TCP/IP_ACK or the like), includes this in an uplink signal to output to the communication control processor 360. The processing on upper layer 352 may output an uplink signal to the communication control processor 360 with data indicating delivery confirmation being included in the uplink signal, or may output an uplink signal to the communication control processor 360 without including data indicating delivery confirmation in the uplink signal. The processing on upper layer 352 may generate data indicating delivery confirmation, and transmit this included in the uplink signal.

The communication control processor 360 executes processing 365 for uplink where a wireless signal is transmitted to the wireless base station device using the wireless circuit 370, and processing for downlink 366 where a wireless signal is received from the wireless base station using the wireless circuit 370 in a time-sharing manner based on a given execution schedule. With the mobile terminal device 300, processing of a wireless signal for uplink and for downlink is executed in a time-sharing manner based on the execution schedule.

Also, the communication control processor 360 may generate data, for example, such as UL-MAC data, DL-MAC data, DL-RLC data, or the like, and exchange these data with the wireless base station device. Details of the UL-MAC data and so forth will be described in a second embodiment.

The communication control processor 360 includes each function block of uplink signal flow measurement 361, uplink signal type measurement 362, execution schedule change 363, execution schedule-based control 364, processing for uplink 365, and processing for downlink 366. For example, the communication control processor 360 reads out the program stored in the ROM which is not illustrated, loads this to the RAM, and executes this loaded program, whereby these function blocks may be executed (realized).

The uplink signal flow measurement 361 measures the data amount of an uplink signal which is input for uplink from the upper processor 350 which executes the function blocks on the higher order layer than a communication layer that the communication control processor 360 executes. The uplink signal flow measurement 361 outputs the measured data amount of the uplink signal to the uplink signal type measurement 362.

The uplink signal type measurement 362 judges whether or not the uplink signal includes data indicating delivery confirmation in the upper layer, based on the measured data amount. For example, the uplink signal type measurement 362 may judge this based on whether or not the data amount is data amount with a given size, or whether or not a counter which has counted data having the data amount with a given size in unit time has reached a given number of times, or the like.

The execution schedule change 363 changes, in the event that judgment is made at the uplink signal type measurement 362 that the uplink signal includes data indicating delivery confirmation in the upper layer, the time-sharing execution schedule so as to raise the execution order of the processing for uplink 365.

The execution schedule-based control 364 performs control the processing for uplink 365 and processing for downlink 366 based on the execution schedule. The execution schedule is a schedule wherein the processing for uplink 365 and processing for downlink 366 are performed in a time-sharing manner, for example.

The execution schedule-based control 364 instructs the processing for uplink 365 to transmit an uplink signal including data identifying delivery confirmation in the upper layer to the wireless circuit 370 using the processing for downlink 366 to be executed based on the time-sharing execution schedule after change.

The processing for uplink 365 may perform processing for an uplink signal in accordance with the instructions from the execution schedule-based control 364, and output the signal after processing to the wireless circuit 370. Examples of the processing for an uplink signal include error correction coding processing and modulation processing.

The processing for downlink 366 may perform processing for a downlink signal in accordance with the instructions from the execution schedule-based control 364, and output the signal after processing to the upper processor 350. Examples of the processing for a downlink signal include demodulation processing and error correction decoding processing.

The wireless circuit 370 subjects an uplink signal to frequency conversion processing or the like to convert into a wireless signal, and transmits the wireless signal after conversion to the wireless base station device via the mixer 375 and antenna 376. Also, the wireless circuit 370 subjects a wireless signal received via the antenna 376 and mixer 375 to frequency conversion processing or the like to convert into a baseband signal, and outputs to the communication control processor 360.

In this way, with the communication control processor 360 of the mobile terminal device 300, in the event that judgment is made that data indicating delivery confirmation in the upper layer is included, the time-sharing execution schedule is changed so as to raise the execution order of the processing for uplink 365. According to this change, the execution order of the processing for uplink 365 is raised than that of the processing for downlink 366, whereby the mobile terminal device 300 may transmit a signal including data indicating delivery confirmation in preference to the processing for downlink 366.

Accordingly, the mobile terminal device 300 may transmit an uplink signal including data indicating delivery confirmation in the upper layer in preference to a downlink signal, and improve the transmission throughput of this uplink signal as compared to a case where the uplink signal is not transmitted in preference to a downlink signal.

### Second Embodiment

Next, a second embodiment will be described. First, a configuration example of a communication system according to the present second embodiment will be described, and second, a configuration example of a mobile device included in the communication system and so forth will be described, and finally, an operation example in the mobile device will be described.

Configuration Example of Communication System

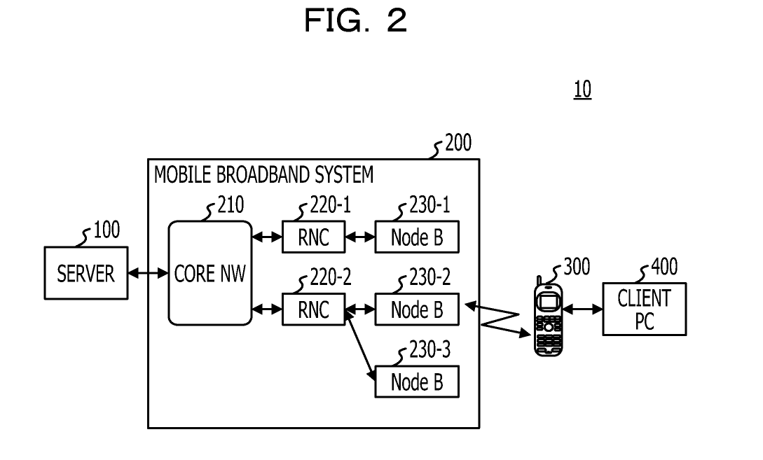

FIG. 2 is a diagram representing a configuration example of a communication system 10 according to the present second embodiment. The communication system 10 includes, for example, a wireless section and a cable section, and the mobile device (or mobile terminal device, and may hereafter be referred to as “mobile device”) 300 transmits/receives data to/from the server 100 via a mobile broadband system 200.

Also, a client personal computer (hereafter, may be referred to as “client PC”) 400 is connected to the mobile device 300. The client PC 400 transmits/receives a TCP/IP packet conforming to the TCP/IP protocol to/from the server 100 via the mobile device 300 and mobile broadband system 200. TCP/IP_ACK is, for example, a delivery confirmation signal conforming to the TCP/IP protocol, and is transmitted to the server 100 from the client PC 400 via the mobile device 300 and mobile broadband system 200.

The communication system 10 includes the server 100, mobile broadband system 200, mobile device 300, and client PC 400. Note that, in the event that a function equivalent to the client PC 400, e.g., a processing unit which processes TCP/IP packets is included in the mobile device 300, the client PC 400 may be omitted.

The server 100 may hold file data, moving image data, and so forth, for example. The server 100 transmits these data to the mobile device 300 or client PC 400 via the mobile broadband system 200 based on the instructions from the client PC 400 or mobile device 300. Also, the server 100 may generate or transmit/receive TCP/IP packet data conforming to the TCP/IP protocol (hereafter, may be referred to as “TCP/IP data”). For example, the server 100 transmits data by packetizing file data, moving image data, or the like into TCP/IP data, or the like. Consequently, the server 100 may include a TCP/IP processing unit which performs processing for TCP/IP data. The server 100 may be connected to the mobile broadband system 200 via the Internet, for example.

Note that a direction from the server 100 to the client PC 400 may be referred to as downlink direction (or down communication link), and a direction from the client PC 400 to the server 100 may be referred to as uplink direction (or up communication link). Further, data flowing in the downlink direction may be referred to as downlink data, and data flowing in the uplink direction may be referred to as uplink data.

The mobile broadband system 200 serves as an interface for enabling data or the like to be transmitted/received to/from the mobile device 300, for example. The mobile broadband system 200 includes a core network (hereafter, may be referred to as “core NW”) 210, an RNC (Radio Network Controller, may be referred to as “wireless base station control device”) 220-1 and 220-2, and NodeB (may be referred to as “wireless base station device”) 230-1 to 230-3.

Note that, with the mobile broadband system 200 illustrated in FIG. 2, an example of two RNC 220-1 and 220-2, and three NodeB 230-1 to 230-3 is represented, but this is an example, and the number of the RNC 220-1 and 220-2 may be one, or three or more. Also, the three or more NodeB 230-1 to 230-3 may be connected to the one RNC 220-1.

The core NW 210 is a network which connects the server 100 and RNC 220-1 and 220-2. TCP/IP data flows to the core NW 210, for example.

The RNC 220-1 and 220-2 may control the single or multiple NodeB 230-1 to 230-3 subordinate thereto. The RNC 220-1 and 220-2 perform control relating to incoming/outgoing for the mobile device 300, control relating to handover, and so forth, for example. Note that the RNC 220-1 and 220-2 may packetize TCP/IP data received from the server 100 via the core NW 210 into RLC packet data (hereafter, may be referred to as “RLC data”) conforming to the RLC (Radio Link Control) protocol, and transmit to each of the NodeB 230-1 to 230-3. Also, the RNC 220-1 and 220-2 may packetize RLC data received from the NodeB 230-1 to 230-3 into TCP/IP data, and transmit to the server 100. The RNC 220-1 and 220-2 may include the RLC processing unit so as to perform conversion between RLC data and TCP/IP data, for example. A configuration example of the RNC 220-1 and 220-2 will be described later.

The NodeB 230-1 to 230-3 convert RLC data received from the RNC 220-1 and 220-2 into a wireless signal, and transmit to the mobile device 300, and convert a wireless signal received from the mobile device 300 into RLC data and transmit to each of the RNC 220-1 and 220-2. A configuration example of the NodeB 230-1 to 230-3 will be described later.

The mobile device 300 receives a wireless signal transmitted from the NodeB 230-1 to 230-3, extracts transmission data from the wireless signal, and transmits to the client PC 400 as reception data. At the time thereof, the mobile device 300 may convert the reception data into data in a given format that may be transmitted to the client PC 400, and transmit to the client PC 400. Also, the mobile device 300 receives data in a given format transmitted from the client PC 400 and transmits this to the NodeB 230-1 to 230-3 as a wireless signal.

Note that, when detecting that TCP/IP data in which no uplink data is included in the data area, and TCP/IP_ACK is included in the header area has been received from the client PC 400, the mobile device 300 may set transmission of uplink data in preference to reception of downlink data. Thus, the mobile device 300 may transmit more many TCP/IP_ACK to the server 100 as compared to before setting. With the server 100, as compared to before setting, the number of time of reception of TCP/IP_ACK increases, the next data of data serving as an object for TCP/IP_ACK may rapidly be transmitted, and improvement in the entire throughput including the application layer may be realized. A configuration example of the mobile device 300 will be described later.

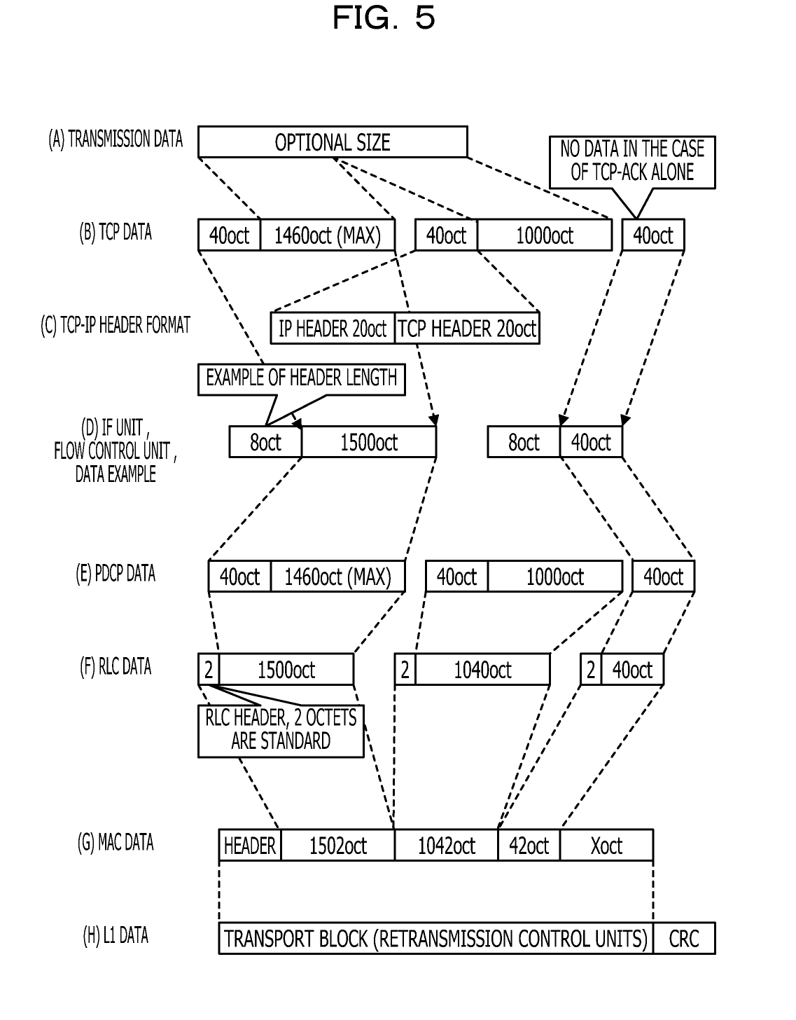

Note that, though a format example of TCP/IP data is represented in (B) in FIG. 5, one TCP/IP packet including a data area and a header area may be referred to as TCP/IP data below as appropriate.

For example, processing for TCP/IP data is performed, and when downlink data transmitted from the server 100 and received from the mobile device 300 is correctly received, the client PC 400 transmits TCP/IP_ACK to the mobile device 300. In this case, the client PC 400 may transmit TCP/IP_ACK by including this in TCP/IP data. The client PC 400 may include a TCP/IP processing unit to enable such processing to be performed. A configuration example of the client PC 400 will be described later.

Configuration Example of Mobile Device 300 and so forth

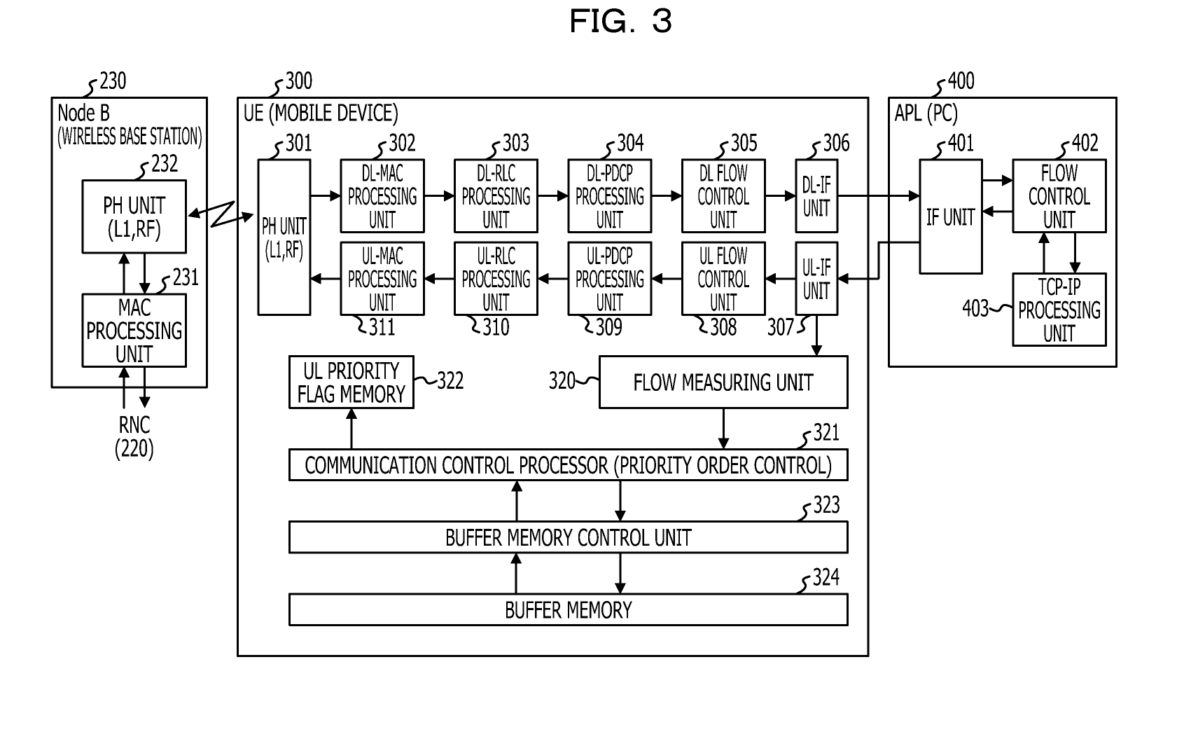

Next, a configuration example of the mobile device 300 and so forth will be described. FIG. 3 is a diagram representing each configuration example of the NodeB 230, mobile device 300, and client PC 400. The client PC 400 illustrated in FIG. 3 may also be represented as an application (APL) within the mobile device 300 or within the client PC 400, for example, and accordingly, the client PC 400 is represented as “APL” in FIG. 3.

Also, a configuration example of the NodeB 230 is also represented in FIG. 3. Though the multiple NodeB 230-1 to 230-3 are represented in FIG. 2, these have the same configuration, and accordingly, these will be referred to as NodeB 230 below unless otherwise noted. The RNC 220-1 and 220-2 will also be referred to as RNC 220 unless otherwise noted.

The NodeB 230 includes an MAC processing unit 231 and a PH unit 232.

The MAC processing unit 231 converts RLC data transmitted from the RNC 220 into MAC data by packetizing the RLC data into MAC packet data (hereafter, may be referred to as “MAC data”) conforming to MAC (Media Access Protocol), or the like, and outputs to the PH unit 232. Also, the MAC processing unit 231 converts MAC data output from the PH unit 232 into RLC data by packetizing the MAC data, or the like, and outputs to the RNC 220. Format examples of the MAC data and RLC data will be described later.

The PH unit 232 converts the MAC data output from the MAC processing unit 231 into a wireless signal to transmit to the mobile device 300, and also receives data transmitted from the mobile device 300, converts this into MAC data, and outputs to the MAC processing unit 231. In this case, the PH unit 232 may convert the MAC data into L1 data, and convert the L1 data into a wireless signal, and transmit this. Also, the PH unit 232 may also extract L1 data from the received wireless signal, and convert the L1 data into MAC data. The PH unit 232 may include an L1 processing unit or RF unit to enable such conversion or extraction or the like to be performed. A format example of the L1 data will be described later.

The mobile device 300 includes a PH unit 301, a DL-MAC processing unit 302, a DL-RLC processing unit 303, a DL-PDCP processing unit 304, a DL-flow control unit 305, a DL-IF unit 306, a UL-IF unit 307, a UL-flow control unit 308, a UL-PDCP processing unit 309, a UL-RLC processing unit 310, a UL-MAC processing unit 311, and a UL-PH unit 311. The mobile device 300 further includes a flow measuring unit 320, a communication control processor (hereafter, may be referred to as “communication processor”) 321, a UL priority flag memory 322, a buffer memory control unit 323, and buffer memory 324.

With the configuration example of the mobile device 300 in FIG. 3, the blocks from the DL-MAC processing unit 302 to the DL-IF unit 306 are blocks to each perform processing for downlink data. Also, the blocks from the UL-IF unit 307 to the UL-MAC unit 311 are blocks to each perform processing for uplink data.

Note that, with a configuration example of the mobile terminal device 300 according to the first embodiment (e.g., FIG. 1), the communication control processor 360 corresponds to, for example, the DL-MAC processing unit 302 to DL-IF unit 306, UL-IF unit 307 to UL-MAC processing unit 311, flow measuring unit 320, communication control processor 321, UL priority flag memory 322, buffer memory control unit 323, and buffer memory 324. Also, the wireless circuit 370, mixer 375, and antenna 376 according to the first embodiment correspond to, for example, the PH unit 301 according to the second embodiment.

The PH unit 301 receives a wireless signal transmitted from the NodeB 230, extracts L1 data from the wireless signal, further extracts data included in the transport block from the L1 data, and outputs to the DL-MAC processing unit 302. Also, the PH unit 301 converts data in increments of transport blocks output from the UL-MAC processing unit 311 into L1 data by adding CRC, or the like. The PH unit 301 converts the L1 data into a wireless signal, and transmits to the NodeB 230. The PH unit 301 may include a L1 processing unit, a RF processing unit, and so forth so as to perform such extraction, conversion, and so forth. Note that details regarding such conversion will be described later.

The DL-MAC processing unit 302 converts data included in the transport block output from the PH unit 301 by packetizing this into MAC data, or the like, and outputs the MAC data to the DL-RLC processing unit 303. Note that details regarding such conversion will be described later.

The DL-RLC processing unit 303 converts MAC data output from the DL-MAC processing unit 302 by packetizing this into RLC data, or the like, and outputs to the DL-PDCP processing unit 304. This conversion will also be described later.

The DL-PDCP processing unit 304 converts RLC data output from the DL-RLC processing unit 303 into PDCP data by packetizing this into PDCP packet data (may be referred to as “PDCP data”) conforming to the PDCP (Packet Data Convergence Protocol), or the like. The details of this conversion will also be described later. The DL-PDCP processing unit 304 outputs the PDCP data after conversion to the DL-flow control unit 305.

The DL-flow control unit 305 monitors data input to or output from the DL-flow control unit 305, and controls transmission of uplink data and reception of downlink data and so forth along with the UL-flow control unit 308 based on flow control conditions, for example. The flow control conditions represent conditions regarding transmission of uplink data and downlink data such that reception of downlink data is prioritized over transmission of uplink data, for example. For example, the DL-flow control unit 305 outputs a signal to the effect that the data amount of downlink data becomes or does not become equal to or less than a threshold, to the UL-flow control unit 308, and the UL-flow control unit 308 may also start transmission of uplink data by receiving the effect signal thereof.

The DL-IF unit 306 converts PDCP data output from the DL-flow control unit 305 into data in a given format to transmit to the client PC 400. The data in a given format may be referred to as “IF data” below as appropriate. A format example of the IF data will be described later.

The UL-IF unit 307 receives the IF data transmitted from the client PC 400, converts the IF data into PDCP data by packetizing the IF data into PDCP data, or the like, and outputs to the UL-flow control unit 308.

The UL-flow control unit 308 controls the amount of uplink data to be output to the UL-PDCP processing unit 309 in accordance with the flow control conditions as described above, for example.

The UL-PDCP processing unit 309 converts PDCP data output from the UL-flow control unit 308 into RLC data by packetizing the PDCP data into RLC data, or the like. The UL-PDCP processing unit 309 outputs the RLC data after conversion to the UL-RLC processing unit 310.

The UL-RLC processing unit 310 converts RLC data output from the UL-PDCP processing unit 309 into MAC data by packetizing the RLC data into MAC data, or the like to output to the UL-MAC processing unit 311.

The UL-MAC processing unit 311 blocks MAC data output from the UL-RLC processing unit 310 for each transport block of a wireless signal, and outputs the blocked transmission data to the PH unit 301.

The flow measuring unit 320 measures, regarding IF data output from the UL-IF unit 307, the data size of TCP/IP data included in this data. Also, the flow measuring unit 320 may also measure data count of TCP/IP data to be output in increments of time. TCP/IP data is included in the IF data. Therefore, the flow measuring unit 320 may measure the data size and data count of TCP/IP data from the IF data output from the UL-IF unit 307. Note that details of measurement will be described later.

The communication processor 321 performs judgment processing based on the data size and data count of the TCP/IP data to be output from the flow measuring unit 320. With the judgment processing, for example, judgment is made whether or not data output from the UL-IF unit 307 is TCP/IP data in which uplink data (e.g., user data) is not included in the data area, and TCP/IP_ACK is included in the TCP header. When judgment is made that the data output from the UL-IF unit 307 is such TCP/IP data, the communication processor 321 performs setting to a UL priority mode. In this case, the communication processor 321 may store a flag indicting that setting to the UL priority mode in the UL priority flag memory 322. Details of the judgment processing and so forth will be described later.

Note that the communication processor 321 is connected to, for example, the DL-MAC processing unit 302 to the DL-IF unit 306, and the UL-IF unit 307 to the UL-MAC processing unit 311, and may instruct conversion of data at each unit and so forth. The communication processor 321 internally holds the flow control conditions and so forth in the DL-flow control unit 305 and UL-flow control unit 308 described above, and may also instruct control of the flow rate of data as to the DL-flow control unit 305 and UL-flow control unit 308 and so forth.

The UL priority flag memory 322 may store a flag indicating that the UL priority mode is to be set (hereafter, may be referred to as “UL priority flag”). For example, when the above-mentioned judgment conditions are not satisfied, the communication processor 321 may delete the UL priority flag. For example, when no UL priority flag is stored in the UL priority flag memory 322, this represents that the present mode is the DL priority mode. Details of the DL priority mode will be described later.

The buffer memory control unit 323 stores IF data output from the UL-IF unit 307 in the buffer memory 324 in accordance with the instructions from the communication processor 321, for example. Also, the buffer memory control unit 323 reads out IF data stored in the buffer memory 324 from the buffer memory 324 to output to the communication processor 321 in accordance with the instructions from the communication processor 321, for example. In this case, for example, the communication processor 321 may output the read IF data to the UL-IF unit 307.

The buffer memory 324 stores IF data output from the UL-IF unit 307 under the control of the buffer memory control unit 323, for example. The format of data to be stored in the buffer memory 324 is not restricted to the IF data, and may be PDCP data or MAC data or the like. Note that the buffer memory 324 may also store downlink data to be output from the DL-IF unit 306.

For example, uplink data is stored in the buffer memory 324 so that the mobile device 300 may transmit the uplink data to the NodeB 230 during a period scheduled at the NodeB 230. Also, for example, downlink data is stored in the buffer memory 324 so that certain amount of data input to the DL-IF unit 306 may be stored and output as IF data. Alternatively, data may also be stored in the buffer memory 324 so as to packetize the data into MAC data, RLC data, PDCP data, and so forth at the MAC processing units 302 and 311, the RLC processing units 303 and 310, the PDCP processing units 304 and 309, the UL-flow control unit 308, and so forth.

Next, a configuration example of the client PC 400 will be described. The client PC 400 includes an IF unit 401, a flow control unit 402, and a TCP/IP processing unit 403.

Note that the upper processor 350 according to the first embodiment corresponds to the client PC 400 according to the present second embodiment, for example.

The IF unit 401 receives IF data transmitted from the mobile device 300, converts the IF data into TCP/IP data by packetizing the IF data into TCP/IP data, or the like, and outputs to the flow control unit 402. Also, the IF unit 401 coverts TCP/IP data output from the flow control unit 402 into IF data, and transmits to the mobile device 300.

The flow control unit 402 controls the flow rate of data to be output to the TCP/IP processing unit 403 or to be transmitted to the mobile device 300 in the same way as with the DL-flow control unit 305 and UL-flow control unit 308 in the mobile device 300, for example.

The TCP/IP processing unit 403 performs processing such as error correction processing or the like on TCP/IP data output from the flow control unit 402. For example, the TCP/IP processing unit 403 generates TCP/IP_ACK in the event that the received TCP/IP data has been received without error. For example, the TCP/IP processing unit 403 may generate one TCP/IP_ACK as to reception data of 2×1460 octets. The TCP/IP processing unit 403 inserts TCP/IP_ACK into the TCP header of the TCP/IP packet data and outputs to the flow control unit 402.

Flow of Data and Configuration Example of Each Data

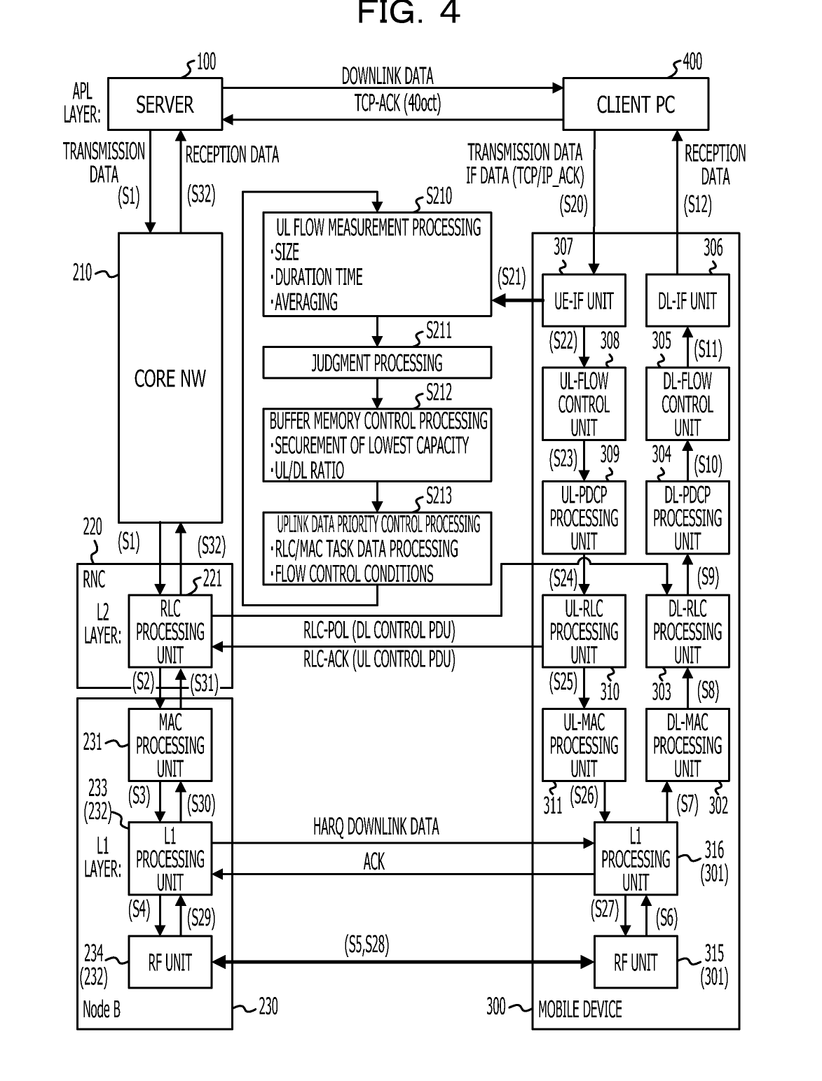

Next, a flow of data to be transmitted/received between the server 100 and the client PC 400 in the communication system 10, and a format example of each data will be described. FIG. 4 represents an example of a data flow, and (A) to (H) in FIG. 5 are diagrams representing a format example.

FIG. 4 represents a scene where downlink data is transmitted from the server 100 to the client PC 400, and represents a scene where TCP/IP_ACK for downlink data or uplink transmission data including TCP/IP_ACK is transmitted from the client PC 400. Hereafter, description will be made regarding a flow after data is transmitted from the server 100 to the client PC 400 until TCP/IP_ACK for the data thereof is sent back to the server 100.

Note that, though FIG. 4 represents a scene where the server 100 and client PC 400 directly transmit/receive downlink data and TCP/ACK, this is for facilitation of description, and actually, transmission/reception is performed via the RF units 315 and 234. With regard to RLC data (RLC_POL and RLC_ACK), downlink data for HARQ control, and ACK (HARQ_ACK) as well, transmission/reception is performed via the RF units 234 and 315.

Also, FIG. 4 illustrates an example wherein the L1 processing unit 233 and RF unit 234 are provided to the PH unit 232 of the NodeB 230 (e.g., FIG. 3), and the RF unit 315 and L1 processing unit 316 are provided to the PH unit 301 of the mobile device 300 (e.g., FIG. 3). Further, an example is also illustrated wherein the RLC processing unit 221 is provided to the RNC 220.

Hereafter, an operation example in FIG. 4 will be described. First, the server 100 transmits data such as file data or moving image data or the like (S1). For example, the server 100 receives instructions from the client PC 400, whereby the server 100 may transmit data based on the instructions thereof. The server 100 may transmit downlink data by packetizing the downlink data into TCP/IP data, for example.

(A) in FIG. 5 represents a format example of transmission data, and (B) in FIG. 5 represents a format example of TCP/IP data, respectively. TCP/IP data includes a header area of 40 octets, and a data area of the maximum 1460 octets. The server 100 may generate TCP/IP data for one packet worth by sectioning transmission data with an optional size for every 1460 octets, taking each thereof as a data area, and adding a header area of 40 octets to the data areas. Also, (C) in FIG. 5 represents a format example of the header area of TCP/IP data, e.g., as for a header area of 40 octets, the areas of a TCP header of 20 octets, and an IP header of 20 octets are provided.

Description will return to FIG. 4. TCP/IP data is transmitted to the RNC 200 via the core NW 210. The RLC processing unit 221 of the RNC 220 converts TCP/IP data into RLC data by packetizing the TCP/IP data into RLC data, and transmits the RLC data to the NodeB 230 (S2).

(F) in FIG. 5 represents a format example of RLC data. RLC data for one packet worth includes, for example, data area including TCP/IP data of the maximum 1500 octets, and an RLC header area of 2 octets. The RLC processing unit 221 may convert TCP/IP data into RLC data of the maximum 1502 octets by including TCP/IP data in the data area, and adding an RLC header of 2 octets to the data area.

Description will return to FIG. 4. The MAC processing unit 231 of the NodeB 230 converts the received RLC data into MAC data by packetizing the received RLC data into MAC data, or the like, and outputs the MAC data to the L1 processing unit 233 (S3).

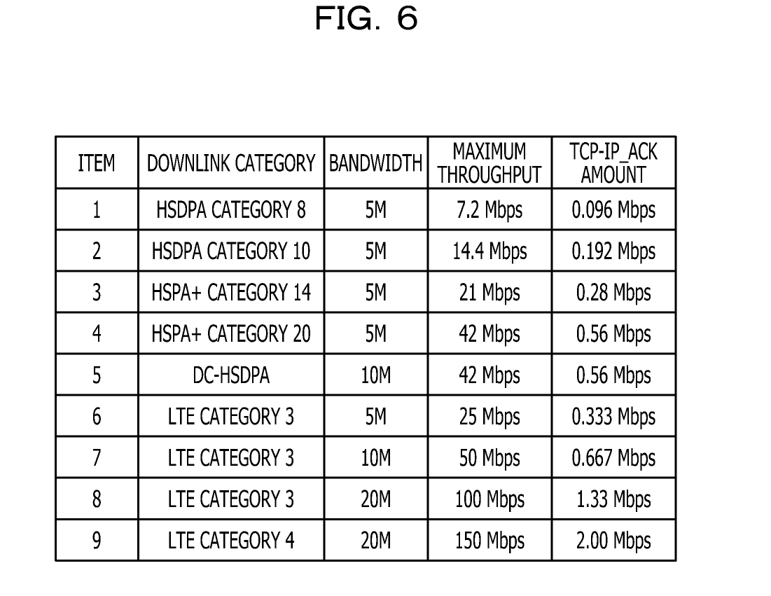

(G) in FIG. 5 represents a format example of MAC data. The MAC processing unit 231 may convert RLC data into MAC data for one packet worth by collecting a plurality of RLC data of the maximum 1502 octets, and adding a MAC header to the collected RLC data, for example. The number of packets of RLC data included in MAC data for one packet worth is based on the type and category of a communication system, for example, such as LTE, HSDPA+, or the like. FIG. 6 represents, with each combination between the type and category of a communication system, bandwidth, the maximum throughput, and the amount of TCP/IP_ACK. As indicated in FIG. 6, according to the category of LTE and the category of HSDPA, the bandwidth, maximum throughput, and so forth differ, and the number of packets of RLC data included in MAC data of one packet, and so forth are determined by the maximum throughput (or communication speed between the mobile device 300 and the NodeB 230) and so forth.

Description will return to FIG. 4. The L1 processing unit 233 converts L1 data into MAC data, and outputs to the RF unit 234 (S4).

(H) in FIG. 5 represents a format example of L1 data. L1 data is, for example, data in which MAC data for one packet worth is blocked as a transport block, and a CRC (Cyclic Redundancy Check) code is added thereto. This transport block becomes retransmission control units at the time of retransmission control conforming to HARQ being performed, and HARQ_ACK may be transmitted in this transport block units.

The RF unit 234 converts L1 data into a wireless signal by subjecting the L1 data to modulation processing, frequency conversion processing, band-pass processing, or the like, and transmits the wireless signal to the mobile device 300 (S5). Therefore, a modulation processing unit, a frequency conversion circuit, a band-pass filter (BPF), and so forth may be provided to the RF unit 234.

Downlink data transmitted from the mobile device 300 is received at the RF unit 315. The RF unit 315 extracts L1 data from the received wireless signal, and outputs the extracted L1 data to the L1 processing unit 316 (S6). In order to enable L1 data to be extracted or converted from a wireless signal, a band-pass filter (BPF), a frequency conversion circuit, a demodulation processing unit, and so forth may be provided to the RF unit 315, for example. A format example of L1 data is indicated in (H) in FIG. 5, for example.

Next, the L1 processing unit 316 performs error correction decoding on the L1 data using a CRC, and in the event that the data of the transport block has correctly been decoded, for example, generates HARQ_ACK, and transmits this to the L1 processing unit 233 of the NodeB 230 via the RF units 315 and 234. The L1 processing unit 316 outputs the correctly decoded transport block to the DL-MAC processing unit 302 (S7).

Next, the DL-MAC processing unit 302 converts the received transport block into MAC data by packetizing the received transport block into MAC data, and outputs to the DL-RLC processing unit 303 (S8). For example, the DL-MAC processing unit 302 may convert the transport block into MAC data by taking the transport block as MAC data of one packet (e.g., see (G) and (H) in FIG. 5).

Next, the DL-RLC processing unit 303 converts the received MAC data into RLC data, and outputs to the DL-PDCP processing unit 304 (S9). For example, the DL-RLC processing unit 303 may convert the MAC data into a plurality of RLC data by extracting each of a plurality of RLC data included in the MAC data based on the MAC header of the MAC data (e.g., (F) and (G) in FIG. 5).

Next, the DL-PDCP processing unit 304 converts the RLC data into PDCP data, and outputs to the DL-flow control unit 305 (S10). For example, the DL-PDCP processing unit 304 may convert the RLC data into PDCP data by terminating the RLC header of two octets from the RLC data of the maximum 1502 octets, and taking the portion of the data area as PDCP data.

(E) in FIG. 5 represents a format example of PDCP data. PDCP data includes a header area of 40 octets, and a data area of the maximum 1460 octets.

Description will return to FIG. 4. Next, the DL-flow control unit 305 receives the PDCP data, and outputs to the DL-IF unit 306 (S11).

Next, the DL-IF unit 306 converts the PDCP data into IF data by packetizing the PDCP data into IF data, and transmits the IF data to the client PC 400 (S12). Conversion into IF data may be performed at the DL-flow control unit 305, for example.

(D) in FIG. 5 represents a format example of IF data. The DL-IF unit 306 may convert the PDCP data into IF data by inserting the PDCP data (e.g., the maximum 1500 octets) into the data area of IF data, for example, and adding a header of 8 octets to the data area. The DL-IF unit 306 transmits the IF data to the client PC 400 (S11, S12).

The client PC 400 receives data transmitted from the mobile device 300, and converts the IF data into TCP/IP data, for example, at the IF unit 401 (e.g., FIG. 3). The client PC 400 may convert the IF data into TCP/IP data by extracting and terminating the header of 8 octets of the IF data, and taking data included in the data area of the maximum 1500 octets as TCP/IP data (e.g., see (B) and (D) in FIG. 5). In the event of having received TCP/IP data without error, the client PC 400 generates TCP/IP_ACK. The client PC 400 may also generate TCP/IP data in which no data (e.g., user data) is included in the data area, and TCP/IP_ACK is included in the header area. Also, the client PC 400 may also generate TCP/IP data in which data or the like is inserted into the areas of the TCP header, IP header, and data (e.g., (B) in FIG. 5).

The client PC 400 converts the generated TCP/IP data into IF data to transmit to the mobile device 300 (S20). For example, the TCP/IP data may be converted into IF data at the IF unit 401 of the client PC 400.

When receiving the IF data transmitted from the client PC 400, the UL-IF unit 307 outputs the IF data to the flow measuring unit 320 (S21).

The flow measuring unit 320 sequentially receives IF data input to the UL-IF unit 307, and performs UL flow measurement processing (S210). With the UL flow measurement processing, the flow measuring unit 320 terminates the header form the IF data, and measures the data size (or packet size) and the data count (or number of packets) per unit time of the data of the maximum 1500 octets included in the data area. The header of the IF data is deleted from the IF data, and TCP/IP data is included in the remained IF data for one packet worth (e.g., (D) in FIG. 5). The flow measuring unit 320 may measure the data size of TCP/IP data and the data count of the TCP/IP data per unit time by measuring the data size of the data for one packet worth.

With regard to the data size, the data size of each TCP/IP data may be detected by the flow measuring unit 320 counting the bits of a continuous bit string regarding data input from the UL-IF unit 307. At this time, the flow measuring unit 320 may also detect the data size of the TCP/IP data by not counting the data of the header area of 8 octets of the IF data.

Alternatively, in the event of having received the IF data, the flow measuring unit 320 may detect the data size of the TCP/IP data (=the data size of the data area of the IF data) by reading out data size information included in the header of the IF data.

Also, as for the data count of the TCP/IP data per unit time, the flow measuring unit 320 may measure the data count by detecting a continuous bit string per unit time of data received from the UL-IF unit 307, for example. For example, the flow measuring unit 320 may count the data count of the TCP/IP data per unit time by counting within unit time such as incrementing the count value by one when detecting a continuous bit string, and incrementing the count value by one when detecting the next continuous bit string.

The flow measuring unit 320 outputs the measured data size of the TCP/IP data, and the measured data count of the TCP/IP data per unit time to the communication processor 321. Next, the communication processor 321 performs judgment processing (S211). With the judgment processing, judgment is made that uplink data to be output from the client PC 400 is TCP/IP data in which data (or user data) is not included in the data area, and TCP/IP_ACK is included in the header area. With regard to specific methods for the judgment processing, there are the following three, for example. Specifically, there are three examples of (1) Judging by continuous count, (2) Judging by the number of TCP/IP_ACK in unit time, and (3) Judging by a ratio between TCP/IP_ACK and data.

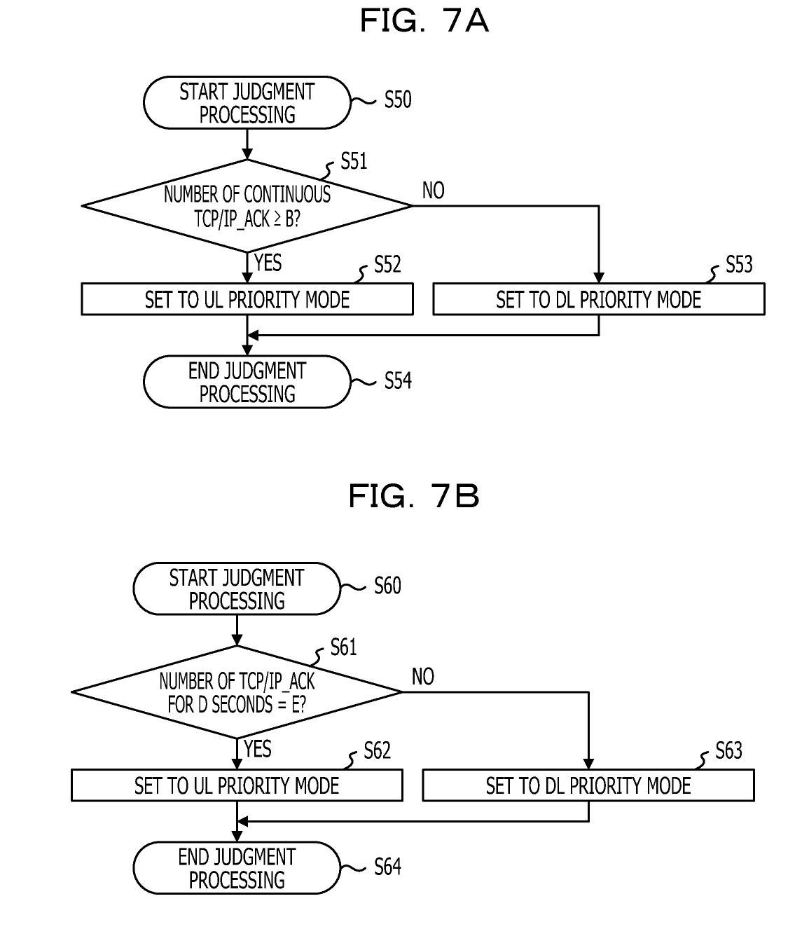

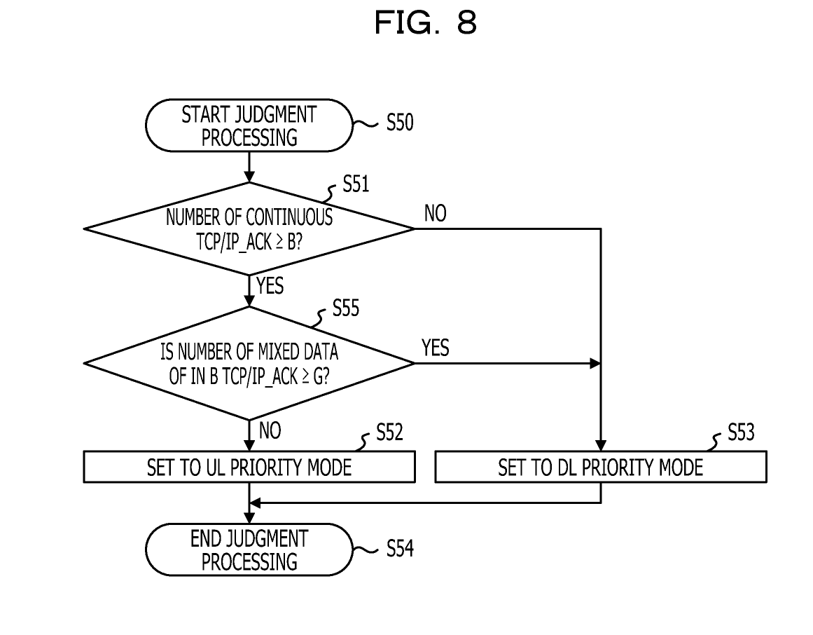

FIGS. 7A to 8 are flowcharts representing three judgment processing examples using the communication processor 321. First, details of the judgment processing will be described with reference to FIGS. 7A to 8, and next, details of the setting processing to the UL priority mode will be described.

(1) Judging by Continuous Count

From the UL-IF unit 307 to the RF unit 315 of the mobile device 300, processing for the L2 layer and L1 layer may be performed, but as for TCP/IP data in the application layer, information or data or the like included in the TCP header or IP header is not read out. With from the RF unit 315 to the DL-IF unit 306 as well, data or the like included in the TCP header or IP header is not be read out. Processing for such TCP/IP data may be performed at the client PC 400 or server 100 in the case of an example such as FIG. 4.

Accordingly, with the mobile device 300 illustrated in the example in FIG. 4, as for uplink data output from the client PC 400, existence/absence of TCP/IP_ACK or the like is not detected directly from the TCP header or the like. However, it is possible to detect that the data output from the client PC 400 is TCP/IP data (=TCP/IP data of the TCP header and IP header alone) in which no data is included in the data area, from the data size thereof. For example, with the example in (B) in FIG. 5, in the case that the data size is 40 octets, the mobile device 300 may detect that this data is TCP/IP data in which not data is included in the data area.

With the present second embodiment, when detecting that the data output from the client PC 400 is TCP/IP data in which no data is included in the data area, it may be detected that this in a state in which TCP/IP_ACK has been transmitted.

For example, with the mobile device 300, there are many cases where the down communication link direction is prioritized over the up communication link direction, and accordingly, there are many cases where the mobile device 300 receives downlink data as compared to a case to transmit uplink data. In the event of receiving downlink data, when data having the same size as the header size of TCP/IP data is detected in the up communication link direction, there are many cases where the data thereof is TCP/IP_ACK for downlink data, as compared to a case where other data or signal is transmitted. An example of this is a case where the client PC 400 is transmitting TCP/IP_ACK for downloaded data in a situation in which moving image data or the like is downloaded.

Accordingly, with the mobile device 300 according to the present second embodiment, when detecting that the size of data received from the client PC 400 is the same data size as the header size of TCP/IP data, it may be detected that TCP/IP_ACK has been transmitted with up communication link.

With the present example, the detection thereof may be judged by continuous count. FIG. 7A is a flowchart representing an operation example of judgment processing in the case of judging the detection with continuous count.

The communication processor 321 may receive, according to the flow measurement processing (S210), the data size and data count of data output from the client PC 400.

Upon starting the judgment processing (S50), the communication processor 321 judges whether or not the detected continuous count of data of which the data size is 40 octets is B (B is an integer equal to or greater than 2), for example (S51). In the event of having detected such data (Yes in S51), the communication processor 321 judges that the data output from the client PC 400 is TCP/IP data in which no data (nor user data) is included in the data area, and TCP/IP_ACK is include in the header area, sets the UL priority mode (S52), and ends the series of processing (S54).

On the other hand, in the event of having detected no data in which the continuous count is B and the data size is 40 octets (No in S51), the communication processor 321 holds the DL priority mode (S53). For example, in the event that the data output from the client PC 400 is TCP/IP data in which data (e.g., user data) is included in the data area, a case may also be conceived where TCP/IP_ACK is included in the header area. However, as described above, with the mobile device 300 illustrated in FIG. 4, information included in the header area of TCP/IP is not read out for processing. Accordingly, in the event of having detected that the data output from the client PC 400 is TCP/IP data in which data is included in the data area, from the data size (No in S51), the communication processor 321 holds the DL priority mode.

Note that, for example, the communication processor 321 may also count the data count assuming that the data of which the data size is 40 octets is continued even if “C” (C is an integer equal to or greater than 1) pieces of data of which the data size is equal to or greater than 40 octets are mixed.

(2) Judging by the Number of TCP/IP_ACK in Unit Time

The communication processor 321 may also judge setting to the UL priority mode by the number of TCP/IP_ACK in unit time based on the data size and data count according to the flow measurement processing (S210), for example.

FIG. 7B is a flowchart representing an operation example of judgment processing by the number of TCP/IP_ACK in unit time. The communication processor 321 may receive the data size and data count of the data output from the client PC 400 from the flow measuring unit 320 by the flow measurement processing (S210).

Upon starting the judgment processing (S60), the communication processor 321 judges whether or not the data count of uplink data of which the data size is 40 octets has reached “E” (E is an integer equal to or greater than 1) for “D” (D is a real number greater than 0) seconds, for example (S61). When counting such data (Yes in S61), the communication processor 321 performs setting to the UL priority mode (S62). In this case as well, the communication processor 321 performs setting to the UL priority mode when detecting a plurality of (here, E pieces of) TCP/IP data in which no data is included in the data area, and TCP/IP_ACK is included in the header area within a certain period of time (“D” seconds in the present example). The communication processor 321 then ends the judgment processing (S64).

On the other hand, for example, in the event that the data count of uplink data of which the data size is 40 octets has not reached “E” for “D” seconds (No in S61), the communication processor 321 holds the DL priority mode (S63), and ends the judgment processing (S64). In this case, in the event that the number of TCP/IP data in which no data is included in the data area, and TCP/IP_ACK is included in the header area is less than a threshold for a certain period of time, setting to the UL priority mode will not be performed.

In this case as well, as with the above-mentioned judgment conditions in (1), the communication processor 321 may also allow mixture of “C” pieces of uplink data of which the data size is equal to or greater than 40 octets, and count these, for example (S61).

(3) Judging by a Ratio Between TCP/IP_ACK and Data

The communication processor 321 may also judge setting to the UL priority mode by a ratio between of TCP/IP_ACK for uplink data based on the data size and data count by the flow measurement processing (S210), for example. In this example, with the judgment processing (1), though an example has been described wherein “C” pieces of TCP/IP data in which uplink data is included in the data area may be mixed for example, such an example is employed, whereby this may be carried out as another example of the judgment processing (1).

FIG. 8 is a flowchart representing an operation example of the judgment processing by a ratio of TCP/IP_ACK. For example, in the event that “B” pieces of data of which the data size is 40 octets has consecutively been detected (Yes in S51), the communication processor 321 judges the ratio of TCP/IP_ACK (S55).

Specifically, in the event that of “B” TCP/IP_ACK, “G” pieces of data of which the data size is greater than 40 octets have been counted (Yes in S55), the communication processor 321 sets the DL priority mode (S53). On the other hand, in the event that of “B” TCP/IP_ACK, the count of data of which the data size is greater than 40 octets is less than “G” (No in S55), the communication processor 321 may hold the UL priority mode (S52). When the data count of TCP/IP data in which uplink data is included in the data area is less than a threshold (“G” in the present example), the data count of such TCP/IP data is small as compared to when equal to or greater than the threshold, and accordingly, mixture of such TCP/IP data is allowed, and the UL priority mode is held.

Note that, with the judgment processing (1) to (3), when detecting that there is no uplink data for a certain period of time (e.g., “A” seconds), the communication processor 321 may change from the UL priority mode to the DL priority mode, or may hold the DL priority mode.

UL Priority Mode

Description will return to FIG. 4. Upon setting to the UL priority mode being judged by the judgment processing (S211), with the mobile device 300, setting to the UL priority mode is performed. The UL priority mode setting processing may include buffer memory control processing (S212) and uplink data priority control processing (S213), for example. The setting processing to the UL priority mode is performed by the communication processor 321 or buffer memory control unit 323, for example.

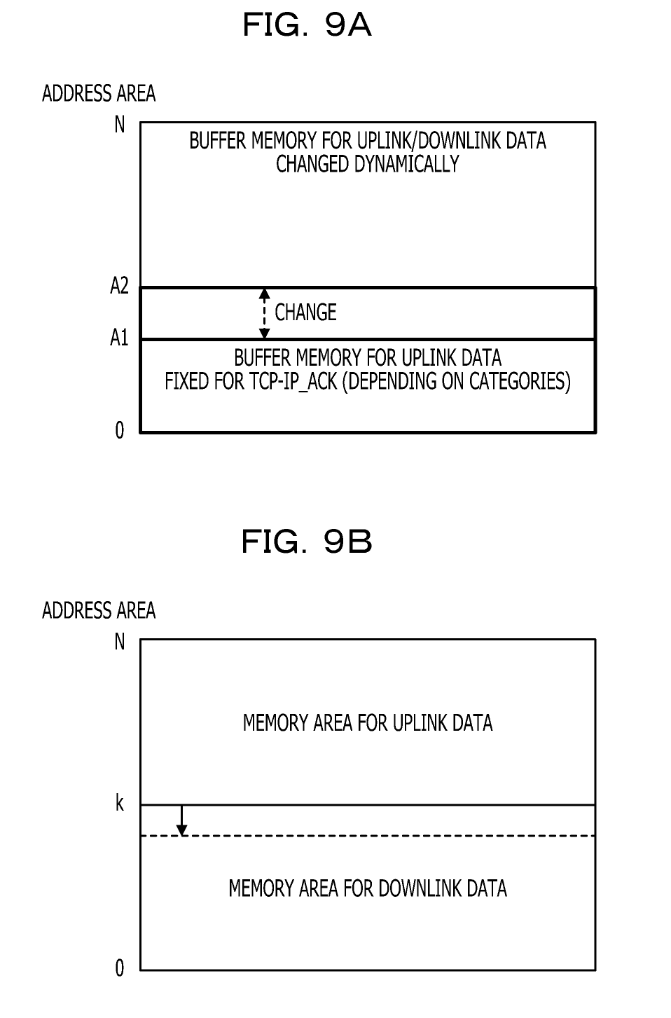

First, an example of the buffer memory control processing (S212) will be described. FIGS. 9A and 9B each represent how the memory area of the buffer memory 324 changes according to the setting to the UL priority mode.

With the example in FIG. 9A, the buffer memory 324 includes a fixed area as an area where TCP/IP_ACK is stored. The size of this fixed area may be changed according to the category of a communication system, for example. With the other areas other than the fixed area, for example, in the event of setting to the UL priority mode having been judged, the memory area may be changed, the buffer memory area for uplink data and the buffer memory area for downlink data may be changed. With change, for example, the memory area for downlink data may be decreased as compared to at the time of the DL priority mode, and the memory area for uplink data may be increased as compared to at the time of the DL priority mode. As for the buffer memory region for uplink data, the capacity thereof may be increased as compared to at the time of the DL priority mode, and accordingly, uplink data to be stored in the buffer memory 324 may be increased as compared to at the time of the DL priority mode. According to such buffer memory control, setting to the UL priority mode may be performed.

For example, upon receiving notification for setting to the UL priority mode from the communication processor 321, the buffer memory control unit 323 secures the fixed area regarding the address area of the buffer memory 324, and further changes the area for uplink data and the area for downlink data. Such change may also be realized, for example, by holding a file system which manages the address area of the buffer memory 324 within the buffer memory control unit 323, and securing or changing an area at the file system.

The example in FIG. 9B is an example wherein no fixed area is secured, and at the time of the DL priority mode, address areas “1” to “k” are taken as memory areas for downlink data, and address areas “k+1” to “N” are taken as memory areas for uplink data. At the time of the UL priority mode, the memory area for uplink data increases as compared to at the time of the DL priority mode, and the memory area for downlink data decreases as compared to at the time of the DL priority mode.

In this way, a ratio thereof is changed between the memory area for uplink data and the memory area for downlink data, for example, whereby setting to the UL priority mode according to buffer memory control may be performed.

Next, the uplink data priority control processing (S213) will be described. For example, an arrangement may be made wherein each task process such as transmission/reception of RLC data, transmission/reception of MAC data, and so forth is performed, and the priority of each task is managed within the mobile device 300. With the uplink data priority control processing, for example, with regard to the priority of each task, transmission of data in the uplink direction is set so as to prioritize this over other processes. Such priority may be held in memory within each processing unit of the DL-MAC processing unit 302 to the DL-flow control unit 305, and the UL-flow control unit 308 to the UL-MAC processing unit 311, and may be changed by instructions from the communication processor 321, for example.

With the uplink data priority control processing (S213), the flow control conditions in the flow control units 305 and 308 may be changed, for example. For example, with the flow control units 305 and 308, instructions for the UL priority mode from the communication processor 321 are accepted, and in this case, in the event that the data amount of downlink data becomes equal to or smaller than a threshold, when uplink is input from the UL-IF unit 307, the uplink data thereof may be output without change. However, with the flow control units 305 and 308, even if instructions for the UL priority mode are accepted, when the data amount of downlink data is equal to or greater than the threshold, output of downlink data may be prioritized. The uplink data priority control processing according to such flow control may be carried out by the communication processor 321 and the flow control units 305 and 308, for example.

Further, with the uplink data priority control processing (S213), in order to enable transmission of TCP/IP_ACK to the NodeB 230, the mobile device 300 may also request the NodeB 230 of assignment of a wireless resource in the uplink direction. The mobile device 300 may transmit a packet including TCP/IP data (e.g., transport block (e.g., (H) in FIG. 5) to the NodeB 230 using the same shared channel as with user data (e.g., PUSCH (Physical Uplink Shared Channel)), for example. As for transmission from the mobile device 300 using the shared channel, for example, an arrangement may be made wherein the mobile device 300 requests the NodeB 230 of assignment of wireless resources (e.g., frequency and time), and the mobile device 300 transmits uplink data using the wireless resources assigned by the NodeB 230. At this time, in order to enable more many TCP/IP_ACK than ever before to be transmitted, the mobile device 300 may request more wireless resources than at the time of the DL priority mode.

In this case, the request amount of wireless resources may be an amount according to the category of a wireless communication system in a section where wireless signals are transmitted/received. For example, as illustrated in FIG. 6, the maximum throughputs and so forth differ according to the category of the wireless communication system thereof, and accordingly, the request amount of wireless resources may also be amount according to the maximum throughput (or communication speed) thereof. Also, for example, the mobile device 300 may also request a wireless resource whereby TCP/IP_ACK may be transmitted while downlink data reception processing or the like is performed. Note that the communication processor 321 may perform request of wireless resources after confirming that the UL priority flag is stored in the UL priority flag memory 322.

In this way, upon judging to perform setting to the UL priority mode (S211), the mobile device 300 performs the buffer memory control processing and the uplink data priority control processing (S212, S213), whereby setting to the UL priority mode may be performed.

Note that, in FIG. 4, the order of the buffer memory control processing (S212) and uplink priority control processing (S213) may be reversed. Also, the mobile device 300 may perform the UL flow measurement processing (S210) again after performing the uplink priority control processing (S213).

Next, though a flow of uplink data of the UL-IF unit 307 and thereafter will be described, reverse processing of the flow of downlink data will be performed at the processing units. For example, with the UL-IF unit 307 or UL-flow control unit 308, the reverse processing of packetizing processing at the DL-IF unit 306 or DL-flow control unit 305 is performed, whereby IF data (e.g., (D) in FIG. 5) may be converted into PDCP data (e.g., (E) in FIG. 5) (S22, S23). Also, with the UL-PDCP processing unit 309 as well, the reverse processing of packetizing processing at the DL-PDCP processing unit 304 is performed, whereby PDCP data may be converted into RLC data and output (S24). Hereafter as well (from S25 to S27), according to processing such as conversion or the like, processing such as packetizing processing at each layer is performed, a wireless signal is transmitted from the mobile device 300 to the NodeB 230 (S28), and uplink data is transmitted to the server 100 via the RNC 220 (S29 to S32).

Operation Example

Next, an operation example in the mobile device 300, and particularly, the judgment processing, UL priority mode setting processing, and so forth will be described, but details thereof have already been described, so only a brief description will be made below.

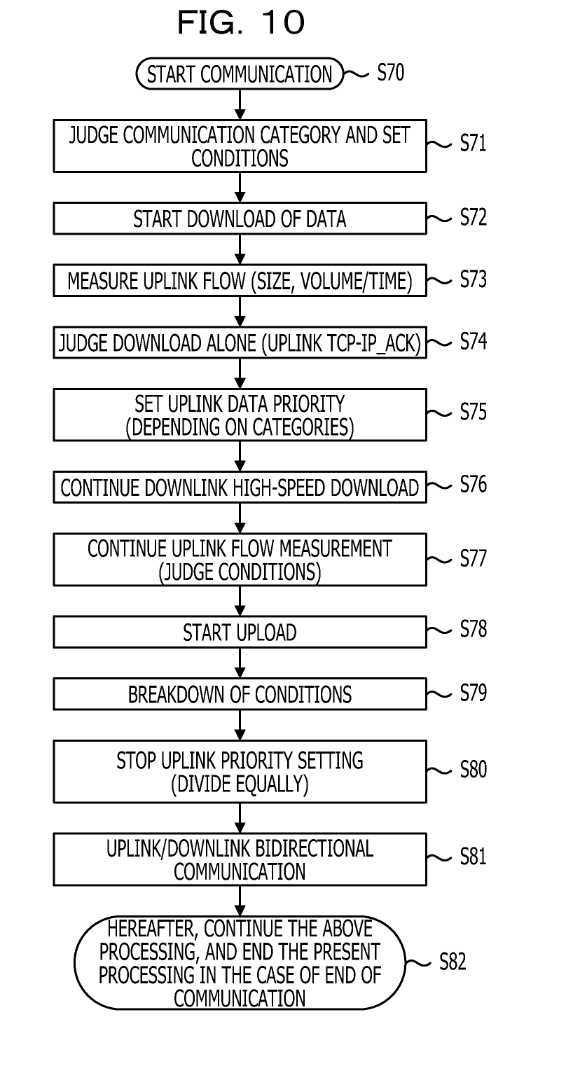

FIG. 10 is a flowchart representing an operation example at the mobile device 300. An operation example will be described with reference to FIG. 10.

First, upon starting communication (S70), the mobile device 300 judges the wireless communication category (e.g., FIG. 6), and sets various conditions such as flow control conditions and so forth (S71). For example, the wireless communication category is informed from the NodeB 230, and accordingly, the mobile device 300 may receive this and hold this in the buffer memory 324 or the like using the communication processor 321 or the like. Also, for example, flow control conditions and so forth are set by the communication processor 321 or the flow control units 305 and 308 or the like. As for an example of various conditions, a ratio between reception of downlink data and transmission of uplink data may be set to a given ratio (e.g., 2:1 or the like). For example, as a flow control condition, flow control may be performed so that a ration between the amount of downlink data and the amount of uplink data becomes 2:1.

Next, the mobile device 300 starts download of data (S72). For example, as illustrated in FIG. 4, data is transmitted from the NodeB 230 via the core NW 210 and RNC 220 from the server 100, and the mobile device 300 receives this, whereby download may be performed. The mobile device 300 may transmit the downloaded data to the client PC 400 (S12 in FIG. 4).

Next, the mobile device 300 measures the uplink flow rate (S73). The mobile device 300 performs the above-mentioned UL flow measurement processing (S210 in FIG. 4), thereby measuring the flow rate of uplink data. For example, uplink data to be measured may be TCP/IP data in which no data is included in the data area and TCP/IP_ACK is included in the header area, or may be TCP/IP data in which data is included in the data area.

Next, the mobile device 300 judges TCP/IP_ACK in the uplink direction (S74). For example, the mobile device 300 may judge TCP/IP_ACK in the uplink direction by continuous count values in the above-mentioned judgment processing (S211) (S51 in FIG. 7), or may judge this by the number of TCP/IP_ACK for unit time (S61 in FIG. 7). Thus, for example, the mobile device 300 may judge that the uplink data is TCP/IP data in which no data is included in the data area and TCP/IP_ACK is included in the header area.

Next, the mobile device 300 performs uplink priority setting (S75). For example, the mobile device 300 performs the above-mentioned setting to the UL priority mode (S52 and so forth in FIG. 7). As for the setting to the UL priority mode, for example, according to the buffer memory control processing (S212 in FIG. 4), uplink data priority control processing (S213), and so forth, the setting at the mobile device 300 may be performed. The example in FIG. 10 is an example wherein the setting to the UL priority mode is performed by the judgment conditions being satisfied.

Next, the mobile device 300 continues download of downlink data (S76), and continues uplink flow measurement (S77). For example, the mobile device 300 may perform the UL flow measurement processing (S210 in FIG. 4) to the uplink data priority control processing (S213 in FIG. 4) and so forth while downloading downlink data. Flow measurement (S73, S77) may be performed as appropriate.

Next, the mobile device 300 starts upload (S78). For example, transmission from the mobile device 300 to the NodeB 230 is upload, and the UL priority mode has been set, and accordingly, TCP/IP data in which uplink data is not included in the data area, and TCP/IP_ACK is included in the TCP header is uploaded.

For example, upload of such data may be performed while processing such as reception processing of data to be downloaded, or the like is not performed. Alternatively, the mobile device 300 requests the NodeB 230 of wireless resources at such timing, and accordingly, upload is performed at such timing. In such a situation, upon the amount of uplink data to be uploaded exceeding a certain threshold (e.g., threshold satisfying a condition wherein a ratio between the amount of downlink data and the amount of uplink data becomes 2:1), reception of downlink data will be neglected, and the conditions determined in S71 (e.g., a condition wherein a ratio between the amount of downlink data and the amount of uplink data becomes 2:1) are not satisfied (S79).

In such a case, the mobile device 300 may cancel the setting to the UL priority mode (S80). According to cancel of the setting to the UL priority mode, for example, the DL priority mode is resumed, and with the buffer memory control processing (S212 in FIG. 4), the buffer memory area may be returned to the state before change to the UL priority mode (e.g., FIGS. 9A and 9B). For example, at the time of the DL priority mode, the memory areas of uplink data and downlink data are in even shares, and at the time of the UL priority mode, the memory area for uplink data increases as compared to the memory area for downlink data, according to cancel of the UL priority mode, the memory areas return to be in even shares. Note that such change in the memory areas may be performed by change in the file system by the buffer memory control unit 323 as described above, for example.

Upon canceling the setting to the UL priority mode, though the setting to the UL priority mode is cancelled, the mobile device 300 is capable of transmitting TCP/IP_ACK and so forth, communication in both-ways of the downlink direction and the uplink direction will be performed (S81). Hereafter, continuously, the present operation may proceed to the processing in S73 again to repeat the processing, or the present operation may be ended in the case that communication at the mobile device 300 is ended (S82).

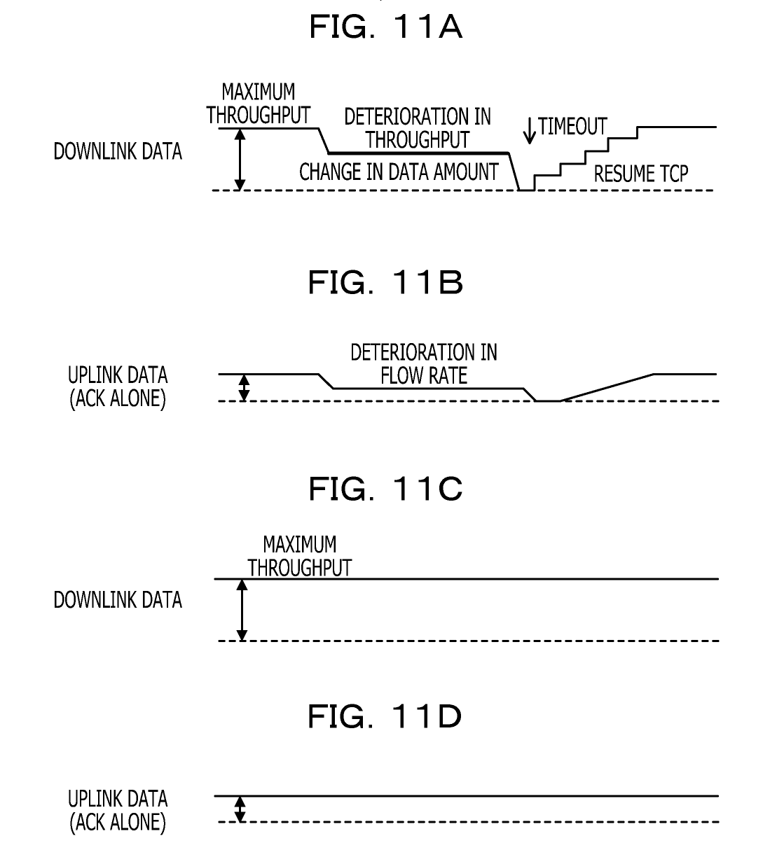

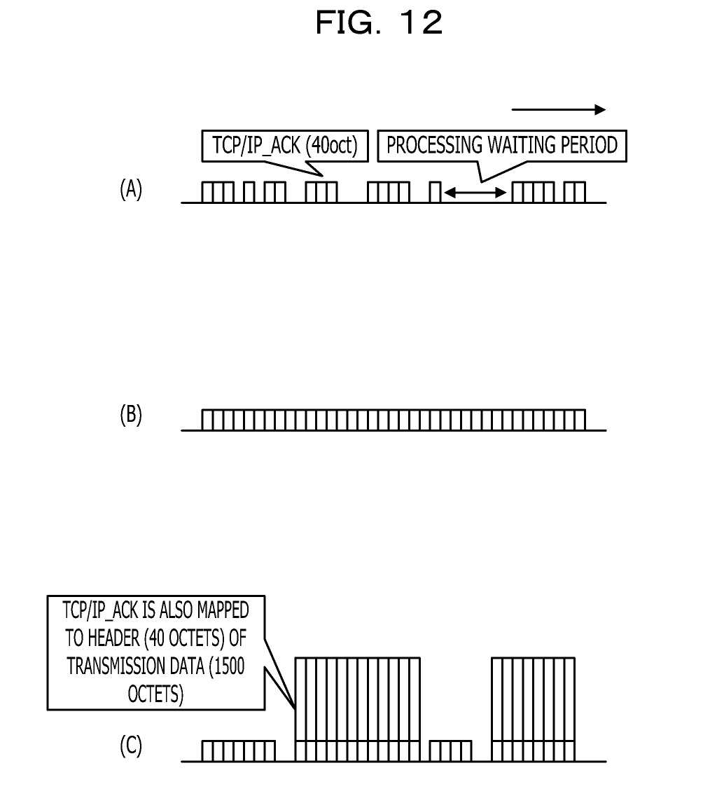

Next, description will be made regarding how each of downlink data and uplink data undergoes a transition according to such an operation at the mobile device 300. FIGS. 11A to 11D each represent an example of data transition, and (A) to (C) in FIG. 12 each represent an example of how a TCP/IP packet undergoes a transition. With either drawing, the horizontal axis represents time, and the vertical axis represents data amount. The data amount in the vertical axis may be taken as data amount at the client PC 400, for example.

FIGS. 11A and 11B represent a transition example of data in the case that the flow rate (or data amount) of uplink data deteriorates with time, which affects on downlink data. FIGS. 11C and 11D represent a transition example of data in the case that uplink data is stabilized, and transmission of downlink data is also stabilized with a specified value.

For example, as represented in FIGS. 11A and 11B, when download of downlink data is performed with the maximum throughput, in the event that the flow rate of uplink data deteriorates for some reason, though transmission of TCP/IP_ACK is enabled, it takes time for transmission as compared to before deterioration. At the time of such a state, as compared to before deterioration, the mobile device 300 takes time for transmission of TCP/IP_ACK, and the server 100 takes time for reception of TCP/IP_ACK. With the server 100 capable of transmitting the next TCP/IP data after confirming reception of TCP/IP_ACK, in such a state, it also takes time for transmission of this data as compared to before deterioration. Thus, the data flow rate of downlink data also deteriorates to below the maximum throughput. When such deterioration continues, transmission of downlink data may be stopped.

On the other hand, as represented in FIGS. 11C and 11D, according to an operation at the present mobile device 300, the transmission amount of TCP/IP_ACK increases by changing to the UL priority mode as compared to before changing to this mode. Thus, with the server 100, as compared to before changing to the UL priority mode, waiting time for reception of TCP/IP_ACK decreases, and transmission speed of downlink data increases. Thus, for example, the data amount of downlink data may keep a stipulated value (the maximum throughput in the example in FIG. 11C). Note that the data amount of uplink data in FIGS. 11B and 11D represents data amount in the case of TCP/IP data in which no data is included in the data area, and TCP/IP_ACK is included in the header area, for example.

(A) to (C) in FIG. 12 represent change in a flow rate at the header area of TCP/IP data. (A) to (C) in FIG. 12 each represent a transmission state at the client PC 400 or a reception state at the server 100, for example. Let us say that TCP/IP_ACK is included in the header area.

(A) in FIG. 12 represents a state in which the flow rate of TCP/IP_ACK fluctuates. At the time of such a state, for example, processing waiting time occurs at the client PC 400, and it takes time for transmission of the next TCP/IP_ACK. According to such processing waiting time, with the server 100, as compared to a case where no processing waiting time occurs, it takes time for reception of TCP/IP_ACK, and it takes time for transmission of data to be downloaded, which causes deterioration in throughput.

On the other hand, according to the setting to the UL priority mode, the transmission amount of TCP/IP_ACK to be transmitted in the uplink direction from the mobile device 300 may be set to a certain amount, for example, as illustrated in (B) in FIG. 12. With the mobile device 300, for example, a certain amount of wireless resources in the uplink direction is requested, whereby the transmission amount of such continuous TCP/IP_ACK may be kept. Thus, as compared to (A) in FIG. 12, improvement in throughput may be realized.

(C) in FIG. 12 represents a state in which TCP/IP data in which data is included in the data area, and TCP/IP data in which no data is included in the data area are transmitted or received in a mixed manner. In such a state, with the mobile device 300, it is impossible to detect TCP/IP data including TCP/IP_ACK from a data size thereof or the like. Therefore, for example, processing waiting time occurs, and consequently, the entire throughput including the application layer deteriorates.

Note that, as described above, with the present second embodiment, addition or modification or the like of certain information is not performed regarding the format of TCP/IP data. Accordingly, with regard to processing for TCP/IP data, there is no modification etc. at the server 100 and client PC 400, and no increase in costs is caused either.

### Other Embodiments

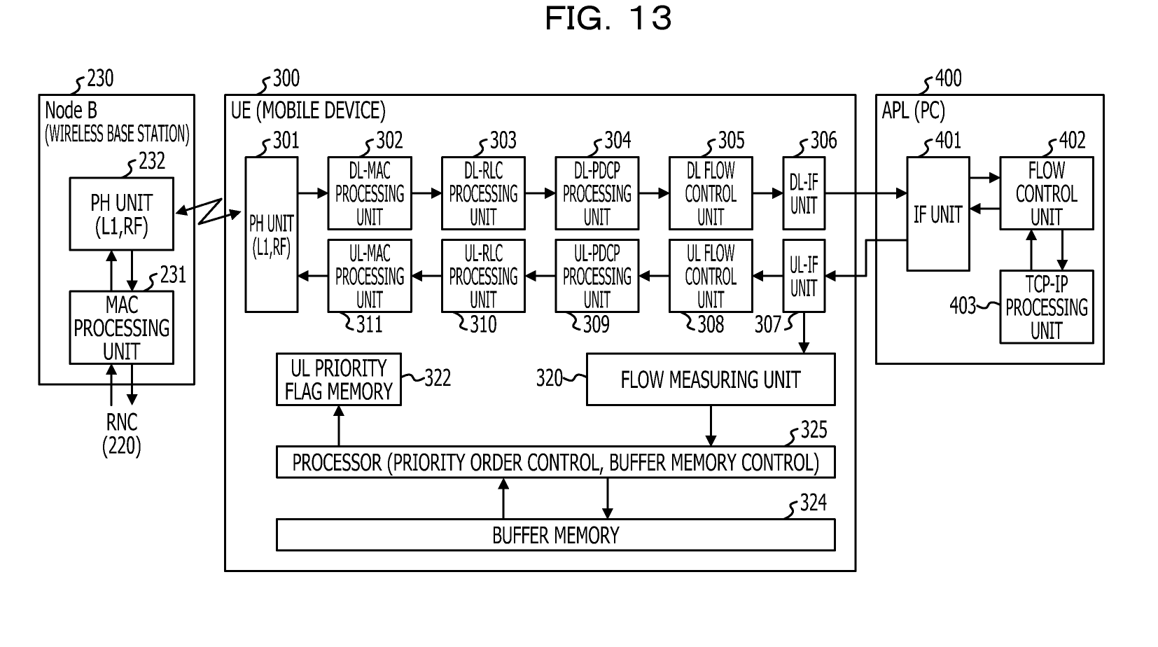

Next, other embodiments will be described. With the second embodiment, description has been made regarding an example wherein the communication processor 321 and buffer memory control unit 323 are separately provided to the mobile device 300. For example, an arrangement may be made wherein one processor performs the functions of the communication processor 321 and buffer memory control unit 323. FIG. 13 represents a configuration example of the mobile device 300, wherein a processor 325 is provided, and the processor 325 may realize the functions of the communication processor 321 and buffer memory control unit 323 according to the second embodiment. For example, the processor 325 may perform the judgment processing and setting processing to the UL priority mode by the communication processor 321, the buffer memory control processing at the buffer memory control unit 323, and so forth.

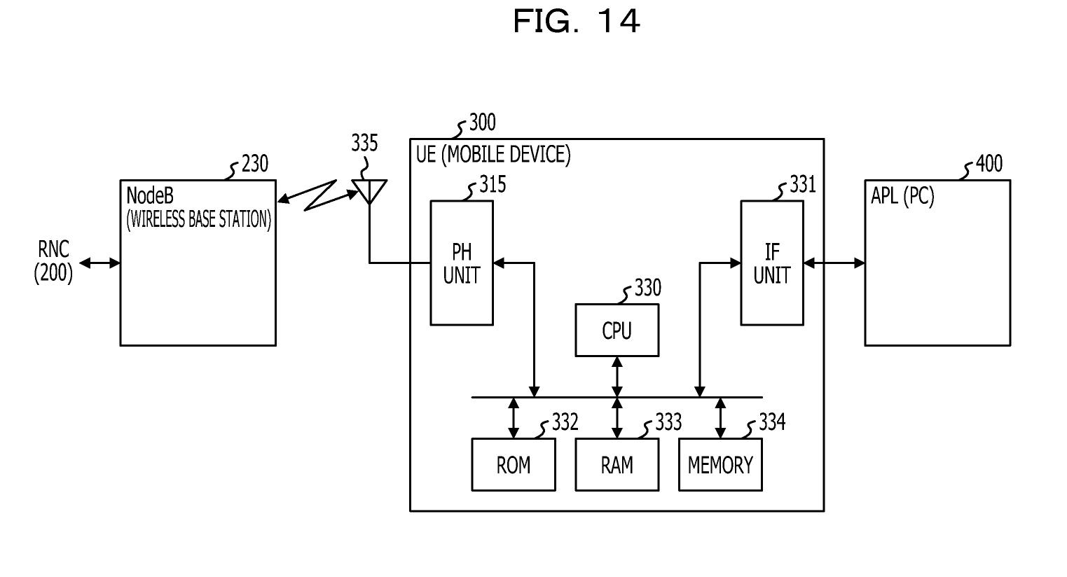

Also, with the second embodiment and so forth, a configuration example of the mobile device 300 has been described with reference to FIGS. 3 and 4. FIG. 14 is a diagram representing a configuration example of another mobile device 300. The mobile device 300 illustrated in FIG. 14 further includes a CPU (Central Processing Unit) 330, an IF unit 331, ROM (Read Only Memory) 332, RAM (Random Access Memory) 333, memory 334, and an antenna 335.

The CPU 330 corresponds to, for example, with the second embodiment, the communication processor 321, buffer memory control unit 323, DL-MAC processing unit 302, DL-RLC processing unit 303, DL-PDCP processing unit 304, DL-flow control unit 305, UL-flow control unit 308, UL-PDCP processing unit 309, UL-RLC processing unit 310, UL-MAC processing unit 311, and L1 processing unit 316. For example, the CPU 330 may execute conversion to each data, the UL flow measurement processing (S210 in FIG. 4) to the uplink data priority control processing (S213), the operation example illustrated in FIG. 10, and so forth.

Note that the CPU 330 corresponds to, for example, the communication control processor 360 according to the first embodiment (e.g., FIG. 1). Also, the RF unit 315 corresponds to, for example, the wireless circuit 370 and mixer 375 according to the first embodiment. Further, the antenna 335 corresponds to, for example, the antenna 376 according to the first embodiment.

The ROM 332 stores a program for executing various types of processing and so forth at the CPU 330, and is allowed to be read out by the CPU 330 as appropriate, for example.

The RAM 333 stores each data and so forth as appropriate, for example, when a program to be executed at the CPU 330 is loaded or when the program is executed, or from which each data and so forth are allowed to be read out.

The memory 334 corresponds to, for example, the buffer memory 324 and UL priority flag memory 322 according to the second embodiment. IF data and so forth are stored in the memory 334, for example.

The antenna 335 transmits a wireless signal output from the RF unit 315 to the NodeB 230, and receives a wireless signal transmitted from the NodeB 230 to output to the RF unit 315.

In this way, according to the mobile device 300 illustrated in FIG. 14 as well, various types of processing such as the judgment processing described in the second embodiment may be executed, and may be carried out in the same way as with the second embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication apparatus comprising:
a wireless circuit; and
a communication control processor configured to
execute processing for uplink and processing for downlink, by using the wireless circuit in a time-sharing manner based on a given execution schedule,
change the time-sharing execution schedule so as to raise an execution order of processing for the uplink, when an uplink signal is judged to include data indicating delivery confirmation in an upper layer based on a data amount of the uplink signal which is input for the uplink from an upper processor which executes processing on the upper layer than a communication layer where the communication control processor executes processing, and
transmit an uplink signal including data indicating delivery confirmation in the upper layer, by using processing for uplink to be executed based on the time-sharing execution schedule after change.

2. The wireless communication apparatus according to claim 1, wherein the communication control processor judges that an uplink signal from the upper processor includes data indicating delivery confirmation in the upper layer, when detecting an uplink signal of which the data amount is given amount multiple times.

3. The wireless communication apparatus according to claim 1, wherein the communication control processor judges that an uplink signal from the upper processor includes data indicating delivery confirmation in the upper layer, when detecting a first uplink signal of which the data amount is given amount multiple times, and also when detecting a second uplink signal of which the data amount is less than given amount a given number of times.

4. The wireless communication apparatus according to claim 1, further comprising:
memory configured to store an uplink signal which is input for the uplink from the upper processor, and a downlink signal which is output for the downlink from the wireless circuit;
wherein the communication control processor changes, when changing the time-sharing execution schedule, a storage area of the memory so as to increase an area in the memory where the uplink signal is stored as compared to before the time-sharing execution schedule is changed.

5. The wireless communication apparatus according to claim 1, wherein the communication control processor transmits all of uplink signals including data indicating delivery confirmation in the upper layer output from the upper processor to the wireless circuit when the data amount of a downlink signal which is output from the wireless circuit and is output for the downlink is less than a threshold after the time-sharing execution schedule is changed.

6. The wireless communication apparatus according to claim 1, wherein the communication control processor requests the wireless base station of assignment of a wireless resource so as to transmit an uplink signal including data indicating delivery confirmation in the upper layer from the wireless circuit after the time-sharing execution schedule is changed.

7. The wireless communication apparatus according to claim 6, wherein the communication control processor requests the amount of the wireless resource according to the category of a wireless communication system.

8. The wireless communication apparatus according to claim 1, wherein the communication control processor further changes the time-sharing execution schedule so as to raise the execution order of processing for the downlink as compared to processing for the uplink when the data amount of an uplink signal including data indicating delivery confirmation in the upper layer to be transmitted from the wireless circuit is equal to or greater than a threshold after the time-sharing execution schedule is changed.

9. A wireless communication method comprising:
executing processing for uplink and processing for downlink, by using a wireless circuit in a time-sharing manner based on a given execution schedule;
measuring a data amount of an uplink signal which is input for the uplink from an upper processor which executes processing at a upper layer than a communication layer of the executing;
judging whether or not the uplink signal includes data indicating delivery confirmation in the upper layer, based on the data amount;
changing the time-sharing execution schedule so as to raise the execution order of processing for the uplink, then the uplink signal is judged to include data indicating delivery confirmation in the upper layer; and
transmitting an uplink signal including data indicating delivery confirmation in the upper layer, by using processing for uplink to be executed based on the time-sharing execution schedule after change.

10. The wireless communication method according to claim 9, wherein, the judging includes judging that an uplink signal from the upper processor includes data indicating delivery confirmation in the upper layer, when detecting an uplink signal of which the data amount is a given amount multiple times.

11. The wireless communication method according to claim 9, wherein, the judging includes judging that an uplink signal from the upper processor includes data indicating delivery confirmation in the upper layer, when detecting a first uplink signal of which the data amount is given amount multiple times, and also when detecting a second uplink signal of which the data amount is less than given amount a given number of times.

12. The wireless communication method according to claim 9, further comprising:
storing an uplink signal which is input for the uplink from the upper processor, and a downlink signal which is output for the downlink from the wireless circuit in memory;
wherein, the changing includes changing, when changing the time-sharing execution schedule, a storage area of the memory is changed so as to increase an area in the memory where the uplink signal is stored as compared to before the time-sharing execution schedule is changed.

13. The wireless communication method according to claim 9, wherein, the transmitting includes transmitting, all of uplink signals including data indicating delivery confirmation in the upper layer output from the upper processor to the wireless circuit when the data amount of a downlink signal which is output from the wireless circuit and is output for the downlink is less than a threshold after the time-sharing execution schedule is changed.

14. The wireless communication method according to claim 9, wherein the wireless base station is requested of assignment of a wireless resource so as to transmit an uplink signal including data indicating delivery confirmation in the upper layer from the wireless circuit after the time-sharing execution schedule is changed.

15. The wireless communication method according to claim 14, wherein the amount of the wireless resource according to the category of a wireless communication system is requested.

16. The wireless communication method according to claim 9, wherein the time-sharing execution schedule is further changed so as to raise the execution order of processing for the downlink as compared to processing for the uplink when the data amount of an uplink signal including data indicating delivery confirmation in the upper layer to be transmitted from the wireless circuit is equal to or greater than a threshold after the time-sharing execution schedule is changed.

17. A storage medium in which a program to be executed at a wireless communication apparatus is stored, the program causing the wireless communication apparatus to perform:
executing processing for uplink and processing for downlink, by using a wireless circuit in a time-sharing manner based on a given execution schedule;
measuring a data amount of an uplink signal which is input for the uplink from an upper processor which executes processing at a upper layer than a communication layer of the executing;
judging whether or not the uplink signal includes data indicating delivery confirmation in the upper layer, based on the data amount;
changing the time-sharing execution schedule so as to raise the execution order of processing for the uplink, then the uplink signal is judged to include data indicating delivery confirmation in the upper layer; and
transmitting an uplink signal including data indicating delivery confirmation in the upper layer, by using processing for uplink to be executed based on the time-sharing execution schedule after change.
